(19) United States
(12) Patent Application Publication
(10) Pub. No.: US 2004/0214975 A1
(43) Pub. Date: Oct. 28, 2004

(54) Precursor material for the production of mechanical objects and a method of production

(76) Inventor: Yan Cang, Shenzhen (CN)

Correspondence Address: Arthur Jacob, 25 East Salem Street, P.O. Box 686, Hackensack, NJ, 07601, US

(21) Appl. No.: 10/768,958

(22) Filed: Jan. 30, 2004

(30) Foreign Application Priority Data
Jan. 30, 2003 (CN) 03 101 978.1

(51) Int. Cl. C08G 2/00

(52) U.S. Cl. 527/300

(57) ABSTRACT

The production of a precursor material suitable for the production of mechanical objects (FIGS. 10, 11, 12) by a forming process is shown. Natural, relatively hard, solid vegetable material, such as waste shell husks are introduced; these consisting predominantly of cellulose. Starch, derived from an agricultural source, is combined with the solid vegetable material and then mixed together with a binding agent, including lipids. After thorough mixing, the resulting mixture is dried and the milling operation is then performed upon the dried mixture to produce precursor powder.

### CROSS-REFERENCE TO RELATED APPLICATION

This application claims priority to Chinese Patent Application No. 03 101 978.1, filed Jan. 30, 2003, the entire disclosure of which is incorporated herein by reference in its entirety as if fully set forth herein.

### BACKGROUND OF THE INVENTION

1. Field of the Invention

The present invention relates to the production of a precursor material suitable for the production of mechanical objects by a forming process.

2Description of the Related Art

In daily living, society uses significant amounts of disposable containers, frequently made from plastics or Styrofoam®, or eco-plastics. Despite the convenience of these materials, the poor biodegradable characteristics that they exhibit is causing significant damage to the environment. Styrofoam®, for example, is known to take up to 200 years -to degrade. Eco-plastics use small grains of plastic bound with starch. This composition hydrolyses with water and leaves behind specks of plastic that cause soil infertility and are difficult to extract from the soil.

Chinese Patent No. 1355261 discloses a “Making of biodegradable tablewares, its formula and its process”. Chinese patent application No. 02114935.6 discloses “Biodegradable tableware, its manufacturing”. Chinese patent application No. 02132545.6 discloses “Starch based environmental material and its making”. These patent specifications describe materials where starch is used as the precursor material, making them expensive to produce.

### BRIEF SUMMARY OF THE INVENTION

According to a first aspect of the present invention, there is provided a method of producing a precursor material suitable for the production of mechanical objects by a forming process, comprising the steps of introducing natural, relatively hard, solid vegetable material consisting substantially of cellulose; combining starch; adding a binding agent to produce a first mixture; drying said first mixture; and milling said dried mixture to produce a precursor powder.

According to a second aspect of the present invention, there is provided a first mixture suitable for the production of mechanical objects, consisting of: solid material derived from a vegetable source of a substantially solid consistency; starch; and a binding agent.

### BRIEF DESCRIPTION OF SEVERAL VIEWS OF DRAWINGS

FIG. 1 shows an overview of a procedure for producing mechanical objects by a forming process;

FIG. 2 shows a step in the procedure overview of FIG. 1 in more detail;

FIG. 3 shows an example of a portion of a cellulose chain;

FIG. 4 shows a step in the procedure overview of FIG. 1 in more detail;

FIG. 5 shows a typical starch molecule;

FIG. 6 shows a step in the procedure overview of FIG. 1 in more detail;

FIG. 7 shows a typical example of a lipid molecule;

FIG. 8 shows procedures for processing precursor material;

FIG. 9 shows a procedure for producing mechanical objects;

FIG. 10 shows a first mechanical object formed from precursor material;

FIG. 11 shows a first mechanical object formed from precursor material;

FIG. 12 shows a first mechanical object formed from precursor material.

### WRITTEN DESCRIPTION OF THE BEST MODE FOR CARRYING OUT THE INVENTION

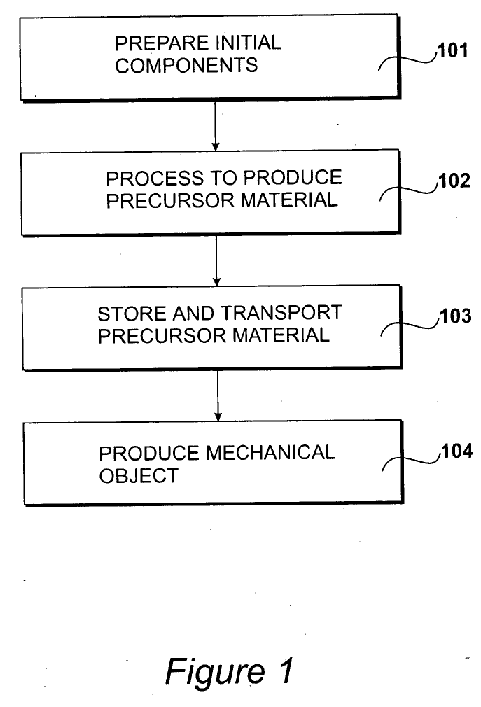

An overview of a procedure for producing mechanical objects by a forming process is illustrated in FIG. 1. At step 101 initial components are prepared; essentially raw materials used in the production process. At step 102 a precursor material is produced from the initial components prepared at step 101, preferably in the form of a powder. Usually, the production of mechanical objects is performed elsewhere and the material is suitable for the production of many different types of object. Thus, at step 103 the precursor material produced at step 102 is stored and may be transported. At step 104 the received precursor material is unpacked and processed so as to produce mechanical objects for use in many different applications.

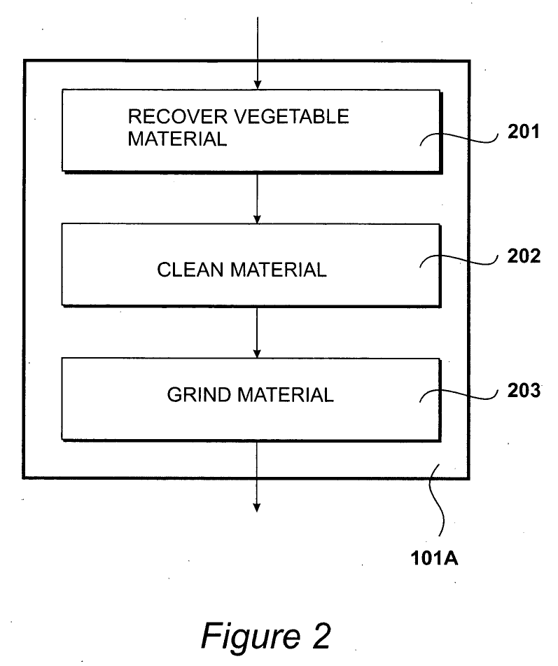

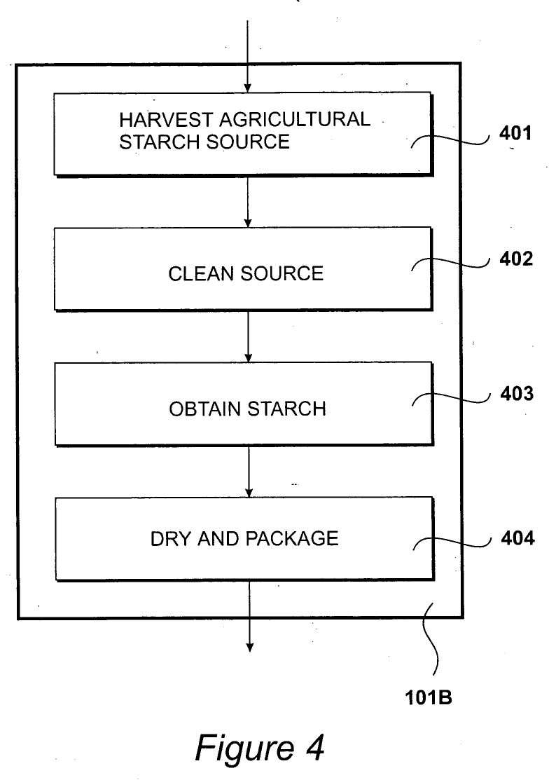

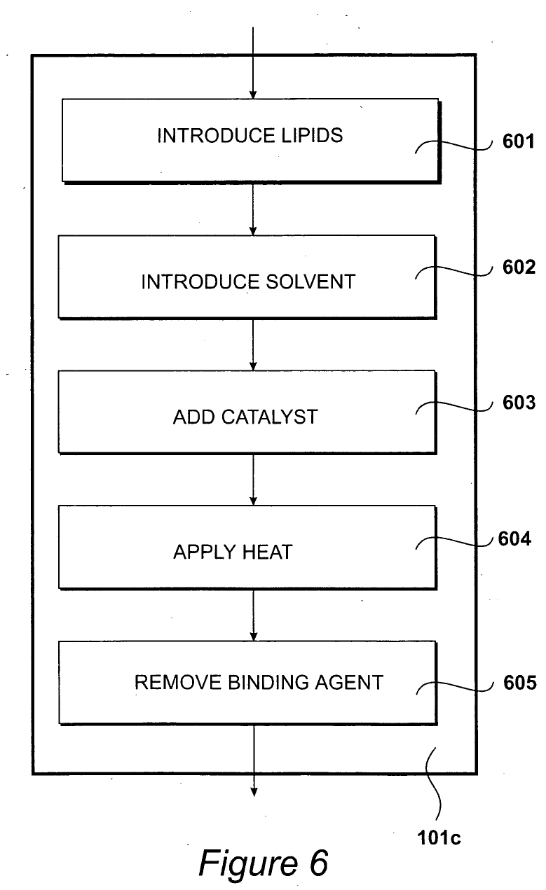

Process 101 for the preparation of initial components, as identified in FIG. 1, includes the preparation of a vegetable material, as illustrated in FIG. 2, the preparation of a starch material, as illustrated in FIG. 4 and the preparation of a binding agent as illustrated in FIG. 6. Thus, step 101 may be considered as step 101a, step 101b, and step 101c.

Step 101a for the preparation of material matter is illustrated in FIG. 2. Preferably the material is relatively hard and derived from a vegetable source and therefore consists substantially of cellulose. Organic fibre materials are preferred such as husks, straws, appropriate food waste, starch or sawdust. Typical husks include rice husks, wheat husks, wheat chaff, sorghum chaff, peanut shells, coconut shells and other types of nut shell. Similarly, straws may include wheat straws, maize straws and sorghum straws. Suitable food waste materials include bagasse, soy bean residue, wine lees and betel palm waste. Furthermore, suitable starch sources include cornflour, riceflour, potato starch and tapioca.

Preferably, this organic fibre material may be recycled from natural agricultural waste fibre. However, care must be taken when recycling waste fibres in that the material may contain contaminants. The inclusion of contaminants may not render the material totally unsuitable but its degree of application may need to be constrained. Thus, it would not be possible to use contaminated material for application for the production of food storage apparatus although material of this type could be used for objects such as ashtrays etc.

At step 201 the vegetable material is recovered, preferably as part of a waste recovery process. Thus, a typical foodstock would include husks, as previously detailed, which would previously have been merely discarded. The vegetable material may comprise material from a combination of vegetable sources. Thus, a useful application has been developed for products that would otherwise be merely treated as waste.

At step 202 the material is cleaned, clearly to an extent dependent on its initial source. Thereafter, at step 203, the material is ground and, in a preferred embodiment, the organic material is preferably ground to a size of particles in the region of 20 micrometers or slightly greater.

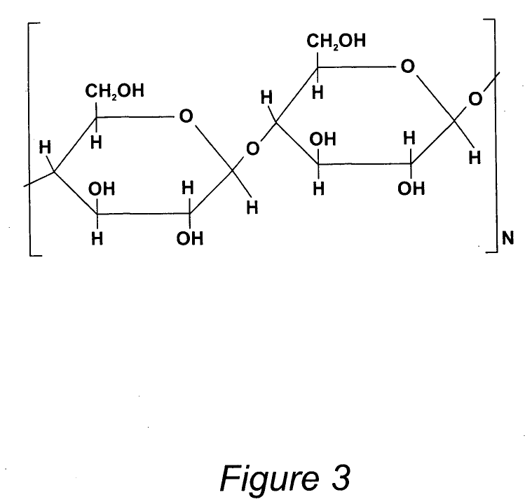

As previously stated, the vegetable fibre foodstock consists substantially of cellulose. An example of a portion of a cellulose chain is illustrated in FIG. 3. Cellulose is an example of a polysaccharide in which the monomeric glucose units are arranged with D-glucopyranosides units linked in a 1:4 fashion in very long unbranched chains. The linkages are beta-glycosidic (unlike starch) and the chains are essentially linear. When two or more cellulose chains make contact, the inclusion of hydroxyl groups results in the formation of hydrogen bonds, which in turn holds the chains together resulting in a fibrous insoluble polymer.

Procedure 101b for the preparation of the starch initial component is illustrated in FIG. 4. At step 401 the agricultural starch source, such as rice or potatoes etc, is harvested. The starch material may comprise material from a combination of starch sources. At step 402 the harvested source is cleaned and at step 403 operations are performed to remove the starch from its agricultural source. Thereafter, at step 404 the removed starch is dried and, where appropriate, packaged.

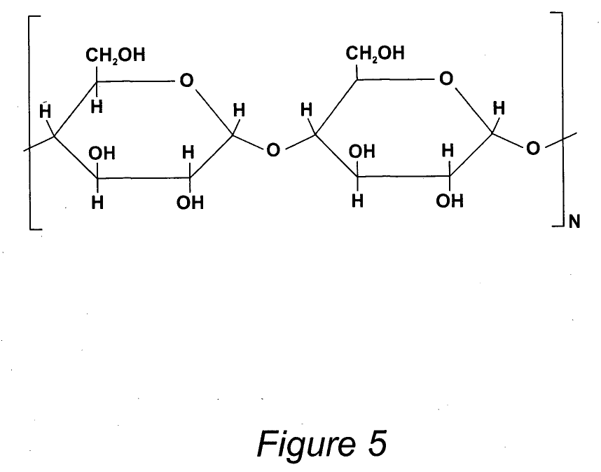

A typical starch molecule is illustrated in FIG. 5. In the source vegetable, the starch occurs as microscopic granules in the roots and tubers etc. Heating starch with water causes the granules to swell and produce a colloidal suspension from which amylose and amylopectin are derived. The amylose structure is illustrated in FIG. 5 and chains of d-glucose units with alpha-glycosidic linkages present in the amylose molecule tend to cause it to assume a helical arrangement, resulting in a compact shape even though its molecular weight is relatively large.

Procedures 101c for the production of a binding agent are illustrated in FIG. 6. The binding agent comprises at least one starch derivative and/or at least one synthetic resin, and high molecular protein. Starch derivatives and synthetic resins are interchangeable with each other, and the substitution of one with another does not alter the binding agent production process.

At step 601 lipids are introduced whereafter at step 602 organic solvent, preferably water, is introduced. At step 603, a catalyst, such as oxalic acid, may be added. Heat is applied at step 604 thereby encouraging polymerisation. Thus, a typical temperature is 70 degrees Celsius and a typical reaction duration is 90 to 120 minutes. The binding agent, in aqueous form, is thereafter removed at step 605. During production step 101c, a solidifying agent may be added depending upon the product intended to be formed from the precursor material.

### EXAMPLE A

### Binding Agent Composition per Metric Tonne

| | | |
|---|---|---|
| Methanal | 480 | kg |
| Urea | 360 | kg |
| Gelatine (or agar) | 10 | kg |
| Polyvinyl alcohol | 10 | kg |
| Melamine | 40 | kg |
| Hexamethylenetetramine | 20 | kg |
| Triethanolamine (or sorbitol) | 640 | ml |

Water: ten (10) times by weight of gelatine added to gelatine and polyvinyl alcohol.

### EXAMPLE B

### Binding Agent Composition per Metric Tonne

As Example A with the Urea, Gelatine (or agar) and Melamine components replaced by Benzene. This composition is not suitable for non-catering products.

### EXAMPLE C

### Binding Agent Composition per Metric Tonne

| | | |
|---|---|---|
| Dialdehyde starch | 980 | kg |
| Gelatine or agar | 20 | kg |
| Triethanolamine (or sorbitol) | 640 | ml |

Water: ten (10) times by weight of gelatine added.

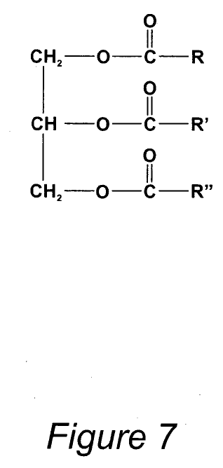

A typical example of a lipid molecule is illustrated in FIG. 7. Lipids include a large variety of structural types and the example shown in FIG. 7 is a triacylglycerol. These are typically the oils of plants and the fats of animal origin derived from sources such as peanut oil, soy bean oil and corn oil. The triacylglycerols are usually mixed, such that the acyl groups are different.

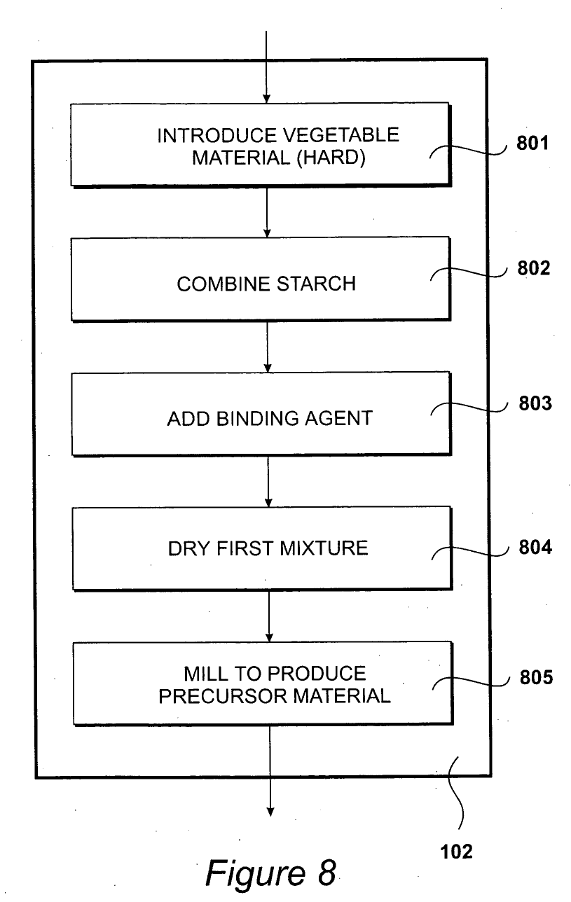

Procedures 102 for the processing of the precursor material are illustrated in FIG. 8. At step 801 the recovered vegetable material, that has been cleaned and ground as illustrated in FIG. 2, is introduced. At step 802 this is combined with the starch produced in accordance with the procedures shown in FIG. 4.

At step 803 the binding agent, produced in accordance with the procedures shown in FIG. 6, is added. The mixture is then preferably agitated and dried for between 20 and 60 minutes, preferably in an industrial drying machine. Preferably, the temperature of drying ranges from 60 to 80 degrees Celsius; preferably 70 degrees Celsius. A typical water reduction is 5-10% of overall mass.

At step 805 the dried first mixture is milled to produce precursor material. The precursor material then takes the form of particles, the size of which may vary depending upon the intended application of the precursor material. Thus, for relatively low value products, the particle size is relatively coarse. High value products, possibly ornamental products, would be produced with a finer grain precursor material.

In many situations it may be preferable to modify colour characteristics of the precursor material, and hence the intended product, during procedure 102. The precursor material may be coloured by the use of organic or inorganic colouring agent to remove and/or add colour. The use of a particular colouring agent, however, may restrict the degree of application of the precursor material. For example, catering products may be coloured using food or edible colouring only. The precursor material may be bleached, however, to remove colour an inorganic dye such as Titanium dioxide (TiO₂), may be added.

As previously stated, at step 103, the precursor material is stored; preferably in a dry environment. A typical shelf life is 7 days when stored in an unsealed environment and 150 days when stored in a sealed environment.

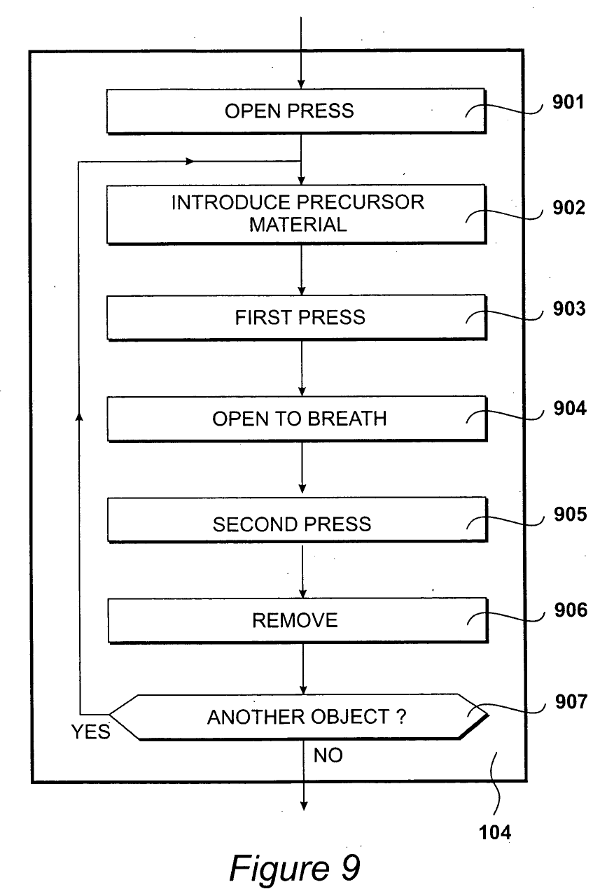

Procedure 104 for the production of the mechanical objects is detailed in FIG. 9. Procedure 104 produces no waste by-product or effluent. At step 901 the press is opened and at step 902 precursor material is introduced into the press. Preferably, a hydraulic machine press is utilised allowing pressure, temperature and duration to be controlled. Pressing pressure is typically 20 to 25 kiloPascals and it is preferable for at least two pressing operations to be performed. The pressing duration is dependent upon the wetness of the precursor material and a typical first press duration is in the range of 1 to 6 seconds, represented by step 903 in FIG. 9. After the first pressing operation at step 903, a breathing operation is performed at step 904. Thus, the press is released and the product is allowed to breathe for typically 1 to 2 seconds. The breathing operation (blowoff) may be effected by separating the mould into two parts. Thereafter, as shown at step 905, a second pressing operation is performed for a duration of typically 15 to 90 seconds.

The mould in which the product is formed is preferably heated to assist the binding process and thus, a typical mould temperature is in the range of 125 to 165 degrees Celsius. The mould may be heated via an electrically heated upper plate and an electrically heated lower plate. Preferably, the upper and lower plates are heated to different temperatures, which facilitates the detachment of the product from the mould and prevents bubbling of the material present in the moulded product. Preferably the lower plate is heated to a higher temperature with the upper plate being heated to a lower temperature thus, a typical temperature for the lower plate is in the range 125 to 155 degrees Celsius and a typical temperature for the upper plate or the mould is in the range 145 to 165 degrees Celsius.

After the second press at step 905, the product is removed from the mould at 906. Thereafter the removed product is allowed to cool naturally, and during this period may be stacked. A question may be asked at step 907 as to whether another object is to be moulded and, when answered in the affirmative, further precursor material may be introduced into the mould at step 902.

The product mould, which for example may be fabricated from steel, may be configured to produce a product having intaglio or relief surface ornamentation. Once the product has been removed from the mould, any hand or machine finishing required may be performed. For example, milling of rough edges may be performed, surface decoration may be added and a non-absorbent coating may be applied. Washing of a mechanical object is not necessary, however, whether this is a requirement depends on the application of the product.

The following Examples D, E, F, G illustrate different precursor material compositions and production processes, and different processes to produce the same mechanical object from precursor material using a two part heated mould.

### EXAMPLE D

### Precursor Material Composition by Weight

| | |
|---|---|
| Binding agent (Example A) | 1 |
| Corn flour | 0.3 |
| Husk | 1.7 |
| Lipid group (zinc stearate) | 0.015 |

Zinc Stearate may be Replaced by the Following Compounds in the Equivalent Molar Quantities:

Calcium stearate

Magnesium stearate

Barium stearate

Precursor Material Production:

The precursor material ingredients are introduced into a mixer. An exothermic reaction occurs at room temperature and pressure with minimum agitation. Reaction duration is 45 minutes. The mixer is opened to release water vapour.

Although drying of the precursor material is not essential, the precursor material is dried at 75 degrees Celsius for 20 minutes.

Mechanical Object Production:

(Number of blowoffs and blowoff duration dependent on
humidity of precursor material)

| | |
|---|---|
| First pressing duration | 5 s |
| Blowoff pressing duration | 5 s |
| Number of blowoff pressings | 3 |
| Breathing distance | 18 mm |
| Final pressing duration | 18 s |
| Pressure | 25 kPa/unit |
| Mould temperature | Upper plate 125-135 degrees Celsius |
| | Lower plate 135-155 degrees Celsius |

### EXAMPLE E

### Precursor Material Composition by Weight

| | |
|---|---|
| Binding agent (Example A) | 1 |
| Corn flour | 0.5 |
| Husk | 1 |
| Lipid group (zinc stearate) | 0.015 |
| Titanium dioxide (TiO₂) | 0.05 |
| Amino solidifying agent | 0.003 |

Amino Solidifying Agent may be Replaced by Oxalic Acid in the Equivalent Molar Quantity.

Alternative Precursor Material Composition by Weight:

| | |
|---|---|
| Binding agent (Example A) | 1 |
| Corn flour | 0.5 |
| Husk | 1 |
| Lipid group | 0.015 |
| Organic dye | subject to |
| | required colour |
| Solidifying agent | 0.003 |

Precursor Material Production:

The precursor material ingredients are introduced into a mixer. An exothermic reaction proceeds at room temperature and pressure with minimum agitation, producing water vapour. Reaction duration is 60 minutes. The mixer is opened to release water vapour.

The precursor material is dried at 75 degrees Celsius for 30 minutes.

Mechanical Object Production:

(Number of blowoffs and blowoff duration dependent on
humidity of precursor material)

| | | |
|---|---|---|
| First pressing duration | 3 | s |
| Blowoff pressing duration | 3 | s |
| Number of blowoff pressings | 3 | |
| Breathing distance | 12-18 | mm |
| Final pressing duration | 20 | s |
| Pressure | 25 | kPa/unit |

| | |
|---|---|
| Mould temperature | Upper plate 145 degrees Celsius |
| | Lower plate 155-165 degrees Celsius |

### EXAMPLE F

### Precursor Material Composition by Weight

| | |
|---|---|
| Binding agent (Example A) | 1 |
| Corn flour | 0.5 |
| Husk | 0.9 |
| Lipid group (zinc stearate) | 0.015 |
| Titanium dioxide (TiO₂) | 0.06 |
| Amino solidifying agent | 0.005 |
| Oxailc acid | 0.0025 |

Precursor Material Production:

The husk is ground into particles having an area of 60 square millimetres.

The precursor material ingredients are introduced into a mixer and mixed until the temperature inside the mixer achieves 45 degrees Celsius, whereafter mixing continues for a further 30 minutes. The precursor material is dried at 75 degrees Celsius for 45 to 60 minutes. The precursor material is then ground into powder form.

Mechanical Object Production:

(Number of blowoffs and blowoff duration dependent
on humidity of precursor material)

| | | |
|---|---|---|
| First pressing duration | 3 | s |
| Blowoff pressing duration | 3 | s |
| Number of blowoff pressings | 2-3 | |
| Breathing distance | 10-12 | mm |
| Final pressing duration | 30 | s |
| Pressure | 25 | kPa/unit |

| | |
|---|---|
| Mould temperature | Upper plate 145 degrees Celsius |
| | Lower plate 155-165 degrees Celsius |

### EXAMPLE G

### Precursor Material Composition by Weight

| | |
|---|---|
| Binding agent (Example A) | 1 |
| Corn flour | 0.5 |
| Husk | 0.8 |
| Lipid group (zinc stearate) | 0.015 |
| Titanium dioxide (TiO₂) | 0.068 |
| Amino solidifying agent | 0.005 |
| Oxailc acid | 0.003 |

Titanium Dioxide may be Replaced by Ultramarine in the Equivalent Molar Quantity.

Precursor Material Production:

The husk is bleached and ground into particles having an area of 60 square millimetres. The precursor material ingredients are introduced into a mixer and mixed at 45 degrees Celsius for at least 60 minutes. The precursor material is then dried at 75 degrees Celsius for approximately 60 minutes.

The precursor material is then ground into powder form.

Mechanical Object Production:

(Number of blowoffs and blowoff duration dependent
on humidity of precursor material)

| | |
|---|---|
| First pressing duration | 3 s |
| Blowoff pressing duration | 3 s |
| Number of blowoff pressings | 2 |
| Breathing distance | 10 mm |
| Final pressing duration | 35 s |
| Pressure | 25 kPa/unit |
| Mould temperature | Upper plate 145 degrees Celsius |
| | Lower plate 155 degrees Celsius |

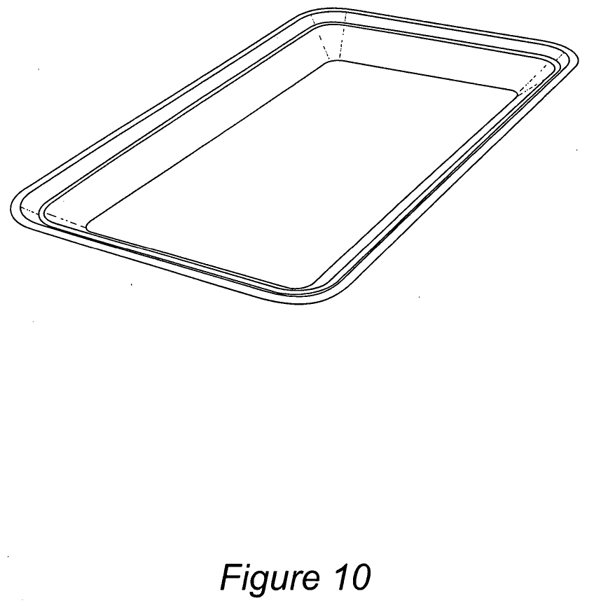

The material produced by the process shown in FIG. 9 is suitable for producing many mechanical objects for use in everyday life. Thus, the process may be used to produce trays for use in domestic environments, fast food environments and medical environments for example. The material is relatively inexpensive to produce and, given its organic origin, will easily biodegrade. Thus, in a fast food environment for example the material has significant advantages over non-biodegradable plastics. Furthermore, given the relatively inexpensive nature of the material, many items that presently tend to be reused could themselves be made for one off use, such as the tray shown in FIG. 10.

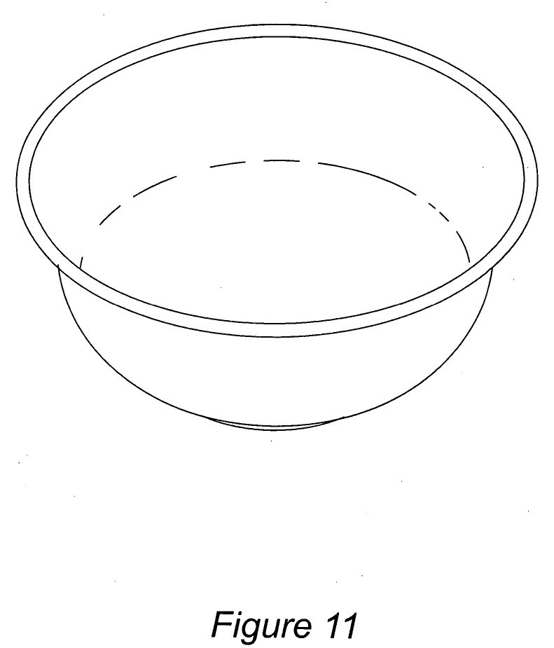

Many dishes and bowls may be produced by the material, such as the bowl shown in FIG. 11, for use in a medical environment. Again, a significant advantage of the material is that its relatively low cost allows many items to be produced for one off use. Furthermore, the nature of the material is such that it is relatively easy to dispose of after the single use has been made. In addition, the moulded product may be decontaminated, for example by a UV irradiation, gamma ray sterilisation or ozone sterilisation process.

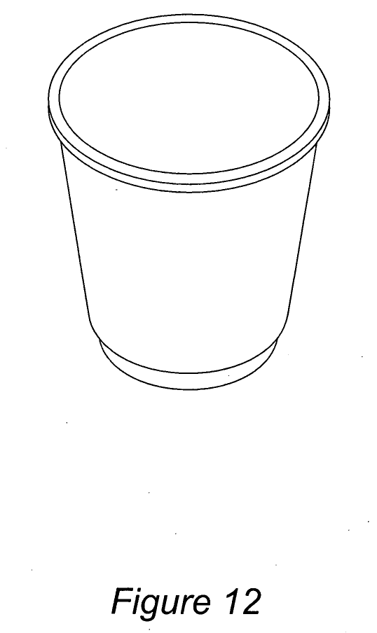

The material is suitable for the production of beverage containers, as illustrated in FIG. 12. The material has the robustness of a solid plastic or ceramic item but its relatively low cost allows it to be used in applications where the material is discarded.

Products that may be formed from precursor material include: disposable food boxes, bowls, cups, plates, trays, cutlery, chopsticks, medical containers and appliances, building materials such as board and bricks; ash trays, candle holders, flower pots, golf balls, computer housings, toys, photo frames, dividers for containers and general packaging.

Products formed from precursor material are biodegradable in several natural environments including in water and in soil. The absorption of water assists in polymer breakdown. When disposed in soil, the precursor material degrades to organic fertiliser(s).

The degradation rate of a mechanical object formed from the same composition of precursor material can be varied by varying the production process as illustrated in Examples H, J, K.

EXAMPLE H

| | |
|---|---|
| Drying of precursor material | None |
| Pressing pressure | 25 kPa |
| Number of presses | 5 |
| Pressing duration | 1 s, 1 s, 1 s, 1 s, 18 s |
| Mould temperature | Upper plate 125 degrees Celsius |
| | Lower plate 145 degrees Celsius |

Degradation Starts to degrade within approximately one month of disposal in natural conditions, complete degradation in approximately 6 months.

EXAMPLE J

| | |
|---|---|
| Drying of precursor material | 75 degrees Celsius until moderately dry |
| Pressing pressure | 25 kPa |
| Number of presses | 4 |
| Pressing duration | 2 s, 2 s, 2 s, 30 s |
| Mould temperature | Upper plate 125 degrees Celsius |
| | Lower plate 145 degrees Celsius |

Degradation Starts to degrade within approximately 7 days of disposal in water and soil, complete degradation in approximately 6 months.

Starts to degrade within 3-5 months of disposal in natural conditions, complete degradation in approximately 6 months.

EXAMPLE K

| | |
|---|---|
| Drying of precursor material | 75 degrees Celsius until drier than |
| | Example J |
| Pressing pressure | 25 kPa |
| Number of presses | 4 |
| Pressing duration | 2 s, 2 s, 2 s, 25 s |
| Mould temperature | Upper plate 145 degrees Celsius |
| | Lower plate 155-165 degrees Celsius |

Degradation Starts to degrade within 10 days of disposal in water and soil, complete degradation in approximately 6 months.

Starts to degrade within approximately 2 months of disposal in natural conditions, complete degradation in approximately 6 months.

The present invention provides a biodegradable precursor material, from which biodegradable mechanical objects may be formed, displaying one or more of the following properties:

Denser than water.

Variable durability, stability, robustness and flexibility dependent on precursor material composition and manufacture process.

Variable gloss finish dependent on precursor material composition and manufacture process.

Water, oil, ice and other liquids impermeable.

Odourless.

Does not contaminate contents of mechanical objects formed from precursor material.

Temperature resilient between −100° c and +200° c. Can be placed in conventional oven at 200 degrees Celsius for typically 120 minutes without distortion of shape. Microwavable for typically 20-120s without distortion of shape.

Non-flammable to naked flames at room temperature and pressure.

Full disintegration by incineration.

What is claimed:

1. A method of producing a precursor material suitable for the production of mechanical objects by a forming process, comprising the steps of
introducing natural, relatively hard, solid vegetable material consisting substantially of cellulose;
combining starch;
adding a binding agent to produce a first mixture;
drying said first mixture; and
milling said dried mixture to produce a precursor powder.

2. A method according to claim 1, wherein said first mixture is dried for between 20 to 60 minutes.

3. A method according to claim 2, wherein said first mixture is dried at a temperature of between 60 to 80 degrees Celsius.

4. A method according to claim 1, wherein the fineness of said precursor powder varies depending upon the nature of the mechanical object.

5. A method according to claim 1, wherein said binding agent is produced by a process of polymerisation of initial components.

6. A method according to claim 5, wherein an initial component is a lipid.

7. A method according to claim 6, wherein said polymerisation is encouraged by the introduction of oxalic acid catalyst.

8. A method according to claim 1, wherein precursor material is formed into a mechanical object by the application of heat and pressure.

9. A method according to claim 8, wherein the application of said heat and pressure is performed as a two stage procedure with a breathing period between a first application of heat and pressure and a second application of heat and pressure.

10. A first mixture suitable for the production of mechanical objects, consisting of:
solid material derived from a vegetable source of a substantially solid consistency;
starch; and
a binding agent.

11. A first mixture according to claim 10, wherein said binding agent includes a lipid compound.

12. A first mixture according to claim 11, wherein the proportions of said components are:
20 to 95 per cent of said vegetable material;
0.1 to 2 per cent of said starch; and
0.1 to 3 per cent of said lipid compound.

13. A first mixture according to claim 12, also including at least one starch derivative, and/or at least one synthetic resin and/or a mixture of high molecular weight proteins.

14. A first mixture according to claim 10, wherein said solid vegetable material is derived from husks, straw, food waste, starch or sawdust.

15. A first mixture according to claim 10, wherein said starch is agricultural starch.

16. A first mixture according to claim 11, wherein said lipid compound is produced by a process of polymerisation.

17. A precursor material derived from said first mixture produced according to claim 10 by a process of drying and milling.

18. A mechanical object derived from said precursor material produced according to claim 17 by a process involving the application of heat and pressure.
